(19) United States
(12) Patent Application Publication
(10) Pub. No.: US 2007/0094871 A1
(43) Pub. Date: May 3, 2007

(54) Method for manufacturing a printed circuit board with a film capacitor embedded therein, and a printed circuit board obtained thereby

(75) Inventors: Jin Seok Moon, Suwon (KR); Yul Kyo Chung, Yongin (KR); Seung Hyun Sohn, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/592,169

(22) Filed: Nov. 3, 2006

(30) Foreign Application Priority Data
Nov. 3, 2005 (KR) 10-2005-0104674

(51) Int. Cl. H01G 7/00

(52) U.S. Cl. 29/832; 361/540; 29/834; 361/305; 174/256; 29/25.42

(57) ABSTRACT

The invention provides a method for manufacturing a printed circuit board with a film capacitor embedded therein and a printed circuit board obtained thereby. In the method, a lower electrode is formed on an insulating substrate. An amorphous dielectric film is formed on the lower electrode by low temperature film formation. Also, a metal seed layer is formed on the dielectric film by electroless plating. An upper electrode is formed on the metal seed layer by electrolytic plating.

### CLAIM OF PRIORITY

This application claims the benefit of Korean Patent Application No. 2005-104674 filed on Nov. 3, 2005 in the Korean Intellectual Property Office, the disclosure of which is incorporated herein by reference.

### BACKGROUND OF THE INVENTION

1. Field of the Invention

The present invention relates to a method for manufacturing a printed circuit board with a film capacitor embedded therein and a printed circuit board obtained thereby. More particularly, the present invention relates to a printed circuit board with a film capacitor embedded therein in which a metal seed layer of the film capacitor is formed by electroless plating to reduce manufacturing costs and the film capacitor can be effectively embedded in an organic board by a build-up process, and a printed circuit board obtained thereby.

2. Description of the Related Art

Recently, there has been a rising demand for highly integrated passive devices to ensure higher performance of electronic devices. Nonetheless, a general perception is that various assortments of passive devices mounted on a printed circuit board significantly hinder downscaling of the electronic devices. Especially, semiconductor active devices are equipped with an increasing number of input and output terminals. This requires more passive devices to be mounted around the active devices but such spatial availability is not easily attainable.

The passive device is represented by a capacitor, which needs to be suitably positioned to reduce inductance resulting from a higher frequency trend. For example, a decoupling capacitor for stably supplying a power voltage is necessarily disposed in the closest proximity to an input terminal to diminish inductance resulting from the higher frequency trend.

To meet a demand for miniaturization and higher frequency trend, various types of laminated capacitors with low equivalent series inductance (ESL) have been developed. However a conventional multilayer chip capacitor (MLCC) faces a fundamental limitation in overcoming the problem just described. Meanwhile the capacitor is chiefly used as a device for an electrical circuit. Thus an electrical circuit board having the capacitor embedded therein can be decreased in its size. With this notion, recently a method for manufacturing an embedded capacitor has been vigorously studied.

The embedded capacitor is incorporated in a printed circuit board which is employed in memory cards, PC main boards and all kinds of RF modules, thereby dramatically downsizing the product. Also, the embedded capacitor is disposed in the close proximity to the input terminal of the active device, thereby minimizing electrical lines and remarkably lowering inductance.

This embedded capacitor is disclosed in U.S. Pat. No. 6,818,469. As shown in FIG. 1 of the document, a conventional printed circuit board 10 with a film capacitor embedded therein includes an insulating substrate 11a, a lower electrode 13 formed on the insulating substrate, a dielectric thin film 15 formed on the lower electrode and an upper electrode 17 formed on the dielectric thin film.

In manufacturing the conventional film capacitor, the upper and lower electrodes are formed by physical vapor deposition (PVD) such as sputtering and E-beam. Disadvantageously this causes the electrodes to be formed to a desired thickness at considerable costs. Therefore, this conventional process is hardly applicable to a general build-up process without accompanying realistic limitations.

Furthermore, the aforesaid process involves heating the dielectric thin film at a temperature of at least 400° C. to enhance dielectric properties thereof. Therefore, this process can not be employed in manufacturing the printed circuit board, which is a polymer composite-based insulating substrate.

### SUMMARY OF THE INVENTION

The present invention has been made to solve the foregoing problems of the prior art and it is therefore an object according to certain embodiments of the present invention is to provide a method for manufacturing a dielectric printed circuit board with a film capacitor embedded therein by low temperature film formation at lower costs.

Another object according to certain embodiments of the invention is to provide a printed circuit board manufactured by the method just described.

According to an aspect of the invention for realizing the object, there is provided a method for manufacturing a printed circuit board with a film capacitor embedded therein, the method comprising steps of:

forming a lower electrode on an insulating substrate; forming an amorphous dielectric film on the lower electrode by low temperature film formation;
forming a metal seed layer on the dielectric film by electroless plating; and
forming an upper electrode on the metal seed layer by electrolytic plating.

According to another aspect of the invention for realizing the object, there is provided a printed circuit board with a film capacitor embedded therein, which is manufactured by the method just described.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a printed circuit board with a film capacitor embedded therein according to the prior art;

FIGS. 2a to 2f are cross-sectional views illustrating a method for manufacturing a printed circuit board with a film capacitor embedded therein according to an embodiment of the invention;

FIG.3 is a cross-sectional view illustrating an embedded film capacitor manufactured according to another embodiment of the invention; and

FIG. 4 is a graph illustrating capacitance of an embedded film capacitor manufactured according to further another embodiment of the invention.

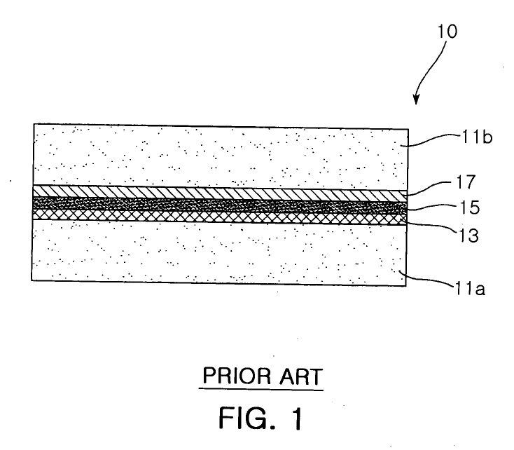

### DETAILED DESCRIPTION OF THE PREFERRED EMBODIMENT

Preferred embodiments of the present invention will now be described in detail with reference to the accompanying drawings.

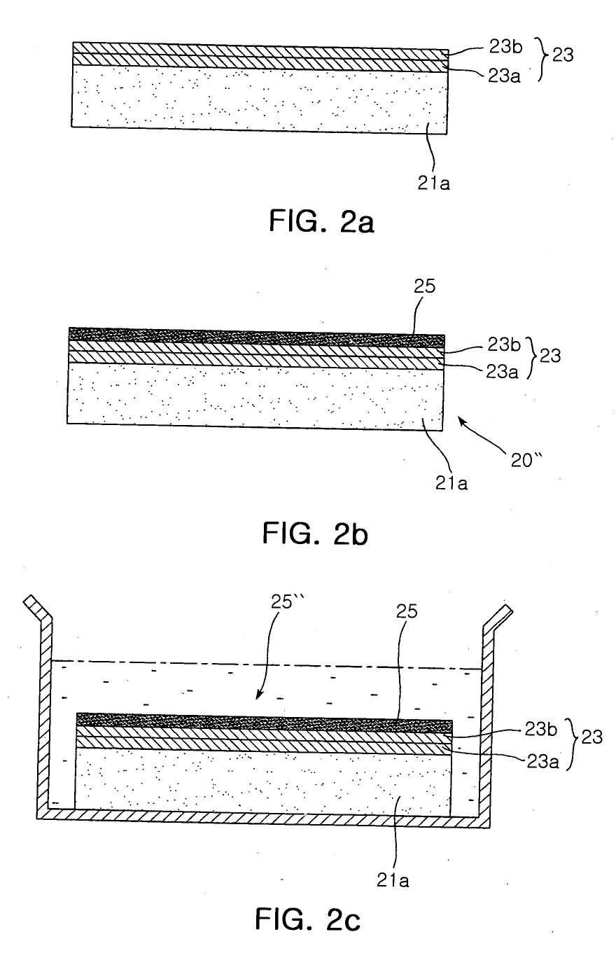

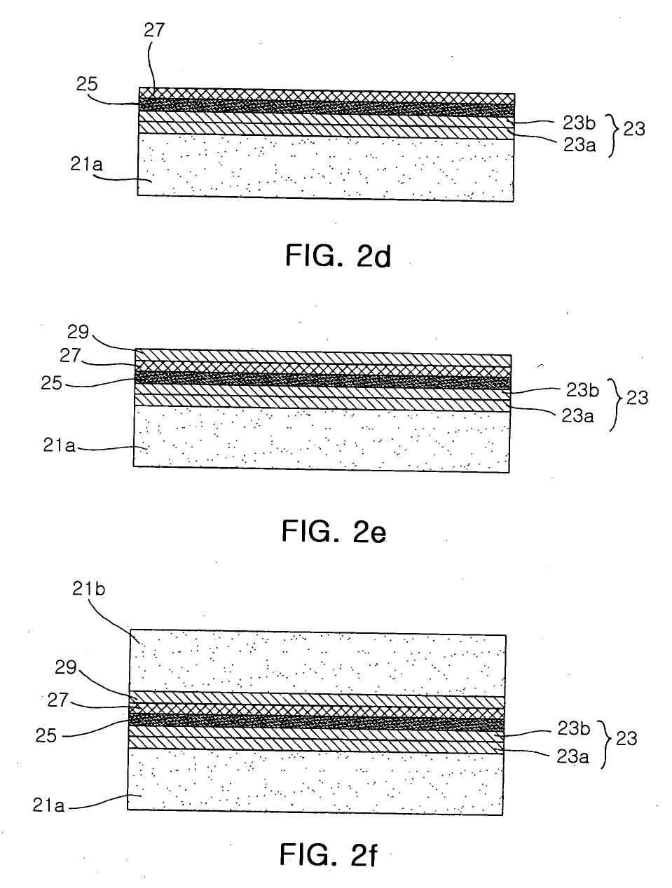

FIG. 2 is a cross-sectional view illustrating a method for manufacturing a printed circuit board according to the invention. As shown in FIG. 2a, first, a lower electrode 13 is formed on an insulating substrate 21a. The lower electrode 23 is made of heat-vulnerable polymer and thus desirably formed by low temperature film formation such as low temperature sputtering, evaporation and electroless plating.

Preferably, the lower electrode 23 is formed on the insulating substrate 21a by conducting electrolytic plating after electroless plating. Here, preferably, the lower electrode 23 is formed to a thickness up to 2.0 μm. More preferably, in the lower electrode 23, a portion formed by electroless plating 23a and a portion formed by electrolytic plating 23b each have a thickness up to 1.0 μm.

Moreover, according to the invention, the lower electrode 23 is preferably made of one selected from a group consisting of Cu, Ni, Al, Pt, Ta and Ag. More preferably, the lower electrode 23 is made of Cu.

Meanwhile, the insulating substrate 21a and 21b is made of polyimid or epoxy, which is typically used to manufacture a printed circuit board.

Then as shown in FIG. 2b, an amorphous dielectric film 25 is formed on the lower electrode 23 formed as just described. Preferably, the dielectric film 25 is formed via low temperature film formation at a temperature up to 200° C. Examples of this process include sputtering, pulsed laser deposition (PLD) or chemical vapor deposition (CVD) using a metal source. The dielectric film 25 obtained by the low temperature film formation is an amorphous metal oxide with sufficient dielectric constant, thereby not necessitating high temperature thermal treatment for crystallization.

Preferably, the amorphous dielectric film 25 is made of a BiZnNb-based amorphous metal oxide and more preferably a metal oxide having a composition expressed by BiₓZn_{y}Nb_{z}O₇ where 1.3<x<2.0, 0.8<y<1.5, and z<1.6. The dielectric film composed of this amorphous oxide may exhibit a high dielectric constant of at least 30, or further at least 40 through low temperature thermal treatment.

Alternatively, the dielectric film 25 is preferably made of one selected from a group consisting of Biₓ(M′_{y}M_{z}″)O₇ oxides satisfying relationships of 1.3<x<2.0, 0.8<y<1.5, and z<1.6 (here M′ is one selected from a group consisting of Zn, Mg, Ni, Sc, In and Cu and M″ is one selected from Nb and Ta), BiₓZn_{y}Nb_{z}Zr_{α}O₇ oxides satisfying relationships of 1.3<x<2.0, y<1.0, z<1.5, α<2.0, BiₓZn_{y}Nb_{z}Gd_{α}O₇ oxides satisfying 1.3<x<2.0, y<1.0, z<1.5,α<2.0 and BiₓNb_{y}O4 oxides satisfying relationships of 1.3<x<2.0, y<1.0.

More preferably, the dielectric film has a thickness up to 2.0 μm.

Then according to the invention, a metal seed layer 27 is formed on the amorphous dielectric film 25 formed as described above via electroless plating.

In general, the elctroless plating involves a conditioner process which is a strong alkaline cleaning process, a pre-dip process, an activator process, a reducer process and final plating. However, the conditioner process which utilizes strong alkali of pH 12 and the pre-dip process which utilizes strong acid of pH 2-3 may potentially dissolve the dielectric film 25 formed.

Therefore, in repeated researches to overcome such a problem, the inventors have found that a desired metal seed layer 27 can be formed via electroless plating that involves only the activator process, reducer process and then final plating process exclusive of the conditioner process and pre-dip process as just described.

That is, first, as shown in FIG. 2c, a stacked structure 20″ having the dielectric film 25 formed therein is subjected to the activator process which is a Pd absorption process. A bath solution utilized in this activator process is composed of 150 to 300 ml/l of Neogant MV activator containing Pd²⁺ and other ions and a predetermined amount of NaOH. Here, NaOH is contained so that the bath solution has a pH of 10.5 to 12.0 , preferably 11.3. Also, preferably, this process is carried out at a temperature of 35 to 50° C.

Preferably, the aforesaid process of the invention is carried out during longer duration than a conventional process. Specifically, the conventional process is maintained for 3 to 5 minutes to absorb Pd²⁺ onto a material, but in this invention, the process time desirably runs for 8 to 12 minutes. This prolonged process boosts Pd²⁺ absorption to increase its adhesion with the material, also improving reaction with Cu, i.e., the bath solution.

Subsequently, the stacked structure 20″ that has undergone the activator process is subjected to the reducer process. This process eliminates Sn, which is bonded to Pd of colloidal component and serves to protect Pd, thereby precipitating Pd metal onto a surface of the dielectric film 25. That is, this is a process of reducing oxidized Pd, i.e., Pd²⁺ back into Pd to be precipitated onto the dielectric film.

Here, the process of the invention lasts for 2 to 5 minutes.

Thereafter the stacked structure 20″ processed as just described is deposited in the bath solution for electroless plating and plated by a conventional method to form the metal seed layer 27 as shown in FIG. 2d. For example, for Cu electroless plating, the bath solution may contain various components such as Cu ions, ethylenediaminetetraacetic acid (EDTA), NaOH and formaldehyde. Therefore, pH of the bath solution can be increased to at least 11 by adjusting an injection amount of NaOH. This allows formaldehyde to experience strong reduction, thereby generating electrons. The electrons generated are provided to Cu ions and are coated on Pd which serves as a catalyst. Consequently Cu is electroless plated on the dielectric film 25.

Here, according to the invention, the metal seed layer 27 is preferably made of one selected from a group consisting of Cu, Ni and Cr, more preferably Cu.

Moreover, the metal seed layer 27 preferably has a thickness up to 0.3 μm.

Next, as shown in FIG. 2a, an external (upper) electrode 29 is formed on the metal seed layer 27 via electrolytic plating.

Also, the upper electrode 29 is preferably made of one selected from a group consisting of Cu, Ni, Al, Pt, Ta and Ag. More preferably, the upper electrode 29 is made of Cu.

Preferably, the upper electrode 29 has a thickness up to 1.0 μm.

Then as shown in FIG. 2f, an insulating substrate 21b is stacked on the upper electrode 29 and the stacked structure is pressurized by a conventional method. This produces a printed circuit board 20 with a film capacitor embedded therein.

As described above, the metal seed layer constituting the film capacitor is formed by electroless plating, thereby driving down manufacturing costs. Also, the printed circuit board with the film capacitor embedded therein can be manufactured effectively by a conventional build-up method for manufacturing a printed circuit board.

An example of the invention will be described in detail hereunder. It is intended, however, that the example is illustrative, but not limitative of the invention.

### EXAMPLE

A lower electrode is formed to a thickness up to 2.0 μm on a substrate made of ABF SH9K by electroless plating and electrolytic plating. Then, a Bismuth Zinc Niobte (BZN) dielectric film having a composition expressed by Bi_{1.5}Zn₁Nb_{1.5}O₇ was deposited on the lower electrode by sputtering. Here, deposition was carried out for up to 3 hours at a temperature up to 200° C. and under a pressure up to 200 mTorr. The dielectric film was deposited to a thickness of about 300 nm.

Then, a metal seed layer was formed on the dielectric film by electroless plating exclusive of conventional. conditioner and pre-dip processes. Here, an activator process was carried out for 8 minutes at a temperature of 40° C. with pH of a bath solution ranging from 10.5 to 12.0. Moreover, a reducer process ran for 3 minutes.

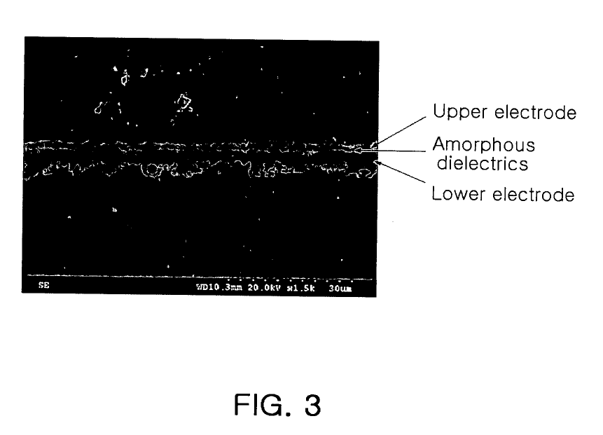

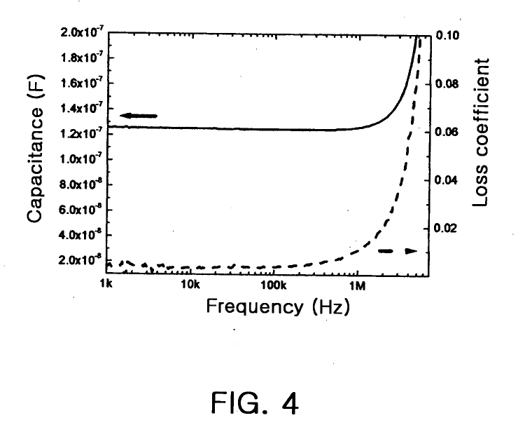

Subsequently, an upper electrode was formed on the metal seed layer via conventional electrolytic plating. Then an insulating substrate of ABF SH9K was stacked on the upper electrode to produce an embedded film capacitor as shown in FIG. 3. Meanwhile, FIG. 4 is a graph illustrating capacitance of the embedded film capacitor manufactured as just described.

As shown in FIG. 3, the invention effectively produces the printed circuit board with the film capacitor embedded therein. Furthermore, as shown in FIG. 4, the invention enables a capacitor to perform with certain capacitance.

As set forth above, according to preferred embodiments of the invention, the invention employs electroless plating in place of a conventional PVD process to form a metal seed layer, thereby reducing manufacturing costs. In addition, the invention effectively produces a printed circuit board with a film capacitor embedded therein via a conventional build-up process.

While the present invention has been shown and described in connection with the preferred embodiments, it will be apparent to those skilled in the art that modifications and variations can be made without departing from the spirit and scope of the invention as defined by the appended claims.

What is claimed is:

1. A method for manufacturing a printed circuit board with a film capacitor embedded therein, the method comprising steps of:
forming a lower electrode on an insulating substrate;
forming an amorphous dielectric film on the lower electrode by low temperature film formation;
forming a metal seed layer on the dielectric film by electroless plating; and
forming an upper electrode on the metal seed layer by electrolytic plating.

2. The method according to claim 1, wherein the upper and lower electrodes each comprise a metal selected from a group consisting of Cu, Ni, Al, Pt, Ta and Ag.

3. The method according to claim 1, wherein the upper and lower electrodes each comprise Cu.

4. The method according to claim 1, wherein the lower electrode is formed by electrolytic plating after electroless plating.

5. The method according to claim 1, wherein the metal seed layer comprises a metal selected from a group consisting of Cu, Ni and Cr.

6. The method according to claim 1, wherein the electroless plating for forming the metal seed layer excludes a conditioner process and a pre-dip process.

7. The method according to claim 1, wherein the electroless plating for forming the metal seed layer comprises carrying out an activator process for at least 8 minutes.

8. The method according to claim 1, wherein the amorphous dielectric film comprises a BiZnNb-based metal oxide dielectric film.

9. The method according to claim 8, wherein the BiZnNb-based metal oxide comprises a BiₓZn_{y}Nb_{z}O₇ metal oxide having a composition expressed by 1.3<x<2.0, 0.8<y<1.5 and z<1.6.

10. The method according to claim 1, wherein the low temperature film formation for forming the amorphous dielectric film is carried out at a temperature up to 200° C.

11. The method according to claim 1, wherein the amorphous dielectric film has a thickness up to 2.0 μm.

12. The method according to claim 1, wherein the lower electrode has a thickness up to 2.0 μm and the upper electrode has a thickness of at least 1.0 μm.

13. The method according to claim 1, wherein the metal seed layer has a thickness up to 0.3 μm.

14. A printed circuit board with a film capacitor embedded therein, manufactured according to claim 1.
